(19) United States
(12) Patent Application Publication
(10) Pub. No.: US 2015/0090845 A1
(43) Pub. Date: Apr. 2, 2015

(54) Medical Device Supporting Apparatus

(71) Applicant: Covidien LP, Mansfield, MA (US)

(72) Inventors: Lester Trelford, St. Louis, MO (US); Joel Wiesner, St. Peters, MO (US); James Harr, Wentzville, MO (US); Kenneth Breitweiser, Brighton, IL (US)

(21) Appl. No.: 14/502,139

(22) Filed: Sep. 30, 2014

Related U.S. Application Data
(63) Continuation-in-part of application No. 14/040,858, filed on Sep. 30, 2013.

(51) Int. Cl. A61J 15/00; F16L 3/237; F16M 13/02; F16L 3/02

(52) U.S. Cl. CPC A61J 15/0053; F16L 3/02; F16L 3/237; F16M 13/022
USPC 248/68.1; 248/65; 248/74.1; 248/284.1; 248/286.1

(57) ABSTRACT

A medical device supporting apparatus for use in a medical environment to releasably secure a medical device to a support structure, the medical device supporting apparatus having a base member configured to releasably mount the medical device supporting apparatus on the support structure; and a medical device mounting assembly including a base attachment portion and a device attachment portion connected to the base attachment portion, and further including a connection mechanism mounting the base attachment portion on the base member for rotation about a roll axis relative to the base member whereby the medical device mounting assembly can hold the medical device at different selected angles about the roll axis with respect to the base member, the device attachment portion being constructed for translational, sliding reception of the medical device into mounting engagement with the device attachment portion. The medical device supporting apparatus also can have a tube holder.

### BACKGROUND

1. Field

This invention relates to a supporting apparatus for a medical device. More particularly, the invention relates to a supporting apparatus that permits a supported medical device to be easily adjusted relative to a support structure without removing the medical device from the supporting apparatus or support structure.

2. Related Art

Medical devices such as enteral feeding pumps are typically attached to a support structure such as an IV pole, a bed rail, or other support structure by means of a pole clamp or other attachment device that holds the pump in a fixed position relative to the support structure. At times, however, it is necessary or desirable to be able to adjust the medical device relative to the support structure. A number of prior art devices have knobs and levers that must be rotated to loosen or unlock the device prior to adjusting the relative position of the device. Further, to lock the device in the adjusted position, the knob/lever must again be rotated. Some of these devices also require removal of the pump or attachment device from the support structure to adjust the position of the pump. These features of the prior art devices can cause use of the devices to be cumbersome and time consuming, and in some cases impossible due to the medical condition of the patient.

### SUMMARY

One or more aspects of the invention can be directed to an apparatus for releasably securing a medical device to a support structure. The supporting apparatus can comprise a base member configured to releasably mount the supporting apparatus on the support structure; and a medical device mounting assembly including a base attachment portion and a device attachment portion connected to the base attachment portion, and further including a first connection mechanism mounting the base attachment portion on the base member for rotation about a roll axis relative to the base member whereby the medical device mounting assembly can hold the medical device at different selected angles about the roll axis with respect to the base member, and a second connection mechanism pivotally mounting the device attachment portion on the base attachment portion for pivoting relative to the base attachment portion about a pitch axis that is generally transverse to the roll axis.

The first connection mechanism and the second connection mechanism can be constructed to permit movement of the medical device about the roll axis and about the pitch axis when mounted on the supporting apparatus solely by grasping and applying force by a user to at least one of the medical device and the device attachment portion. The first connection mechanism can include a holding structure on the base attachment portion that is engageable with the base member for holding the base attachment portion in a selected angular orientation about the roll axis with respect to the base member. The first connection structure can mount the base attachment portion on the base member for movement in a release direction to release the holding structure of the base attachment portion from holding engagement with the base member and permit the base attachment portion to be rotated about the roll axis relative to the base member. In some cases, the first connection mechanism can further include a holding structure on the base member that is engaged with the holding structure of the base attachment portion to hold the base attachment portion in the selected angular orientation about the roll axis with respect to the base member. The holding structure on the base member and the holding structure on the base attachment portion can be configured to hold the base attachment portion in any one of plural, spaced apart angular orientations about the roll axis with respect to the base member. The holding structure on the base member can comprise one of a rib and grooves and the holding structure on the base attachment portion can comprise the other of the rib and the grooves, the rib being receivable in one of the grooves at a time for holding the base attachment portion in a selected angular orientation about the roll axis with respect to the base member. The release direction of the first connection mechanism can be along or parallel the roll axis. The first connection mechanism can comprise a spring connected to the base member and the base attachment portion for biasing the base attachment portion into engagement with the base member. The second connection mechanism can mount the device attachment portion on the base attachment portion for pivoting of the device attachment portion about the pitch axis to any one of plural indexed positions. The second connection mechanism can comprise one of a locking detent and detent receivers on the device attachment portion and the other of the locking detent and the detent receivers on the base attachment portion. The locking detent can be biased toward engagement with one of the detent receivers to hold the device attachment portion and any medical device mounted on the device attachment portion in a selected angular orientation about the pitch axis relative to the base attachment portion. The locking detent can be resiliently yieldable against the bias toward engagement with one of the detent receivers upon application of a torque threshold amount greater than the torque applied about the pitch axis by the weight of the device attachment portion and any medical device mounted on the device attachment portion to pivot the device attachment portion and medical device to a different selected angular orientation about the pitch axis relative to the base attachment portion. The device attachment portion can be constructed for translational, sliding reception of the medical device into mounting engagement with the device attachment portion. The device attachment portion can comprise a retainer engageable with the medical device upon translational, sliding reception of the medical device on the device attachment portion to retain the medical device on the device attachment portion. The retainer can comprise a resilient detent positioned on the device attachment portion to be deformed by the medical device while the medical device moves translationally to slide onto the device attachment portion and to move back toward an undeformed position when a cooperating detent receiver of the medical device comes into registration with the resilient detent for retaining the medical device on the device attachment portion. The device attachment portion can comprise a mount including a pair of retaining flanges, the retaining flanges diverging from each other generally from an upper part of the device attachment portion toward a lower part of the device attachment portion. The device attachment portion can include a rear wall and a bottom wall extending forwardly of the rear wall and positioned for engaging the medical device when mounted on the device attachment portion to support the medical device. The device attachment portion can include a side wall extending forwardly of the rear wall and positioned for engaging the medical device when mounted on the device attachment portion to support the medical device. A retaining arm may extend from the side wall. A tube holder can be mounted on the medical device mounting assembly. The tube holder can be formed integrally with the device attachment portion.

One or more further aspects of the invention can be directed to a medical device supporting apparatus for use in a medical environment to releasably secure a medical device to a support structure. The medical device supporting apparatus can comprise a base member configured to releasably mount the medical device supporting apparatus on the support structure; and a medical device mounting assembly including a device attachment portion supported by the base member, a connection mechanism operatively connecting the device attachment portion to the base member for pivoting about a pitch axis relative to the base member, the device attachment portion being constructed for translational, sliding reception of the medical device into mounting engagement with the device attachment portion.

The connection mechanism typically mounts the device attachment portion on the base attachment portion for pivoting of the device attachment portion about the pitch axis to any one of plural indexed positions. The connection mechanism typically comprises one of a locking detent and detent receivers on the device attachment portion and the other of the locking detent and the detent receivers on the base attachment portion. The locking detent is typically biased toward engagement with one of the detent receivers at a time to hold the device attachment portion and any medical device mounted on the device attachment portion in a selected angular orientation about the pitch axis relative to the base attachment portion. Typically, the locking detent is resiliently yieldable against the bias toward engagement with one of the detent receivers upon application of a torque more than a threshold amount greater than the torque applied about the pitch axis by the weight of the device attachment portion and any medical device mounted on the device attachment portion to pivot the device attachment portion and medical device to a different selected angular orientation about the pitch axis relative to the base attachment portion. The device attachment portion typically comprises a retainer engageable with the medical device upon translational, sliding reception of the medical device on the device attachment portion to retain the medical device on the device attachment portion. The retainer typically comprises a resilient detent positioned on the device attachment portion to be deformed by the medical device while the medical device moves translationally to slide onto the device attachment portion and to move back toward an undeformed position when a cooperating detent receiver of the medical device comes into registration with the resilient detent for retaining the medical device on the device attachment portion. The device attachment portion typically comprises a mount including a pair of retaining flanges, the retaining flanges diverging from each other generally from an upper part of the device attachment portion toward a lower part of the device attachment portion. The device attachment portion typically includes a rear wall and a bottom wall extending forwardly of the rear wall and positioned for engaging the medical device when mounted on the device attachment portion to support the medical device. Typically, the connection mechanism is constructed to permit movement of the medical device about the pitch axis when mounted on the medical device supporting apparatus solely by grasping and applying force to at least one of the medical device and the device attachment portion. The device attachment portion can include a side wall extending forwardly of the rear wall and positioned for engaging the medical device when mounted on the device attachment portion to support the medical device. A retaining arm may extend from the side wall. A tube holder can be mounted on the medical device mounting assembly. The tube holder can be formed integrally with the device attachment portion.

One or more yet further aspects of the invention can be directed to a medical device supporting apparatus for use in a medical environment to releasably secure a medical device to a support structure. The medical device supporting apparatus can comprise a base member configured to releasably mount the medical device supporting apparatus on the support structure and a medical device mounting assembly including a base attachment portion and a device attachment portion connected to the base attachment portion, and further including a connection mechanism mounting the base attachment portion on the base member for rotation about a roll axis relative to the base member whereby the medical device mounting assembly can hold the medical device at different selected angles about the roll axis with respect to the base member, the device attachment portion being constructed for translational, sliding reception of the medical device into mounting engagement with the device attachment portion.

The connection mechanism is typically constructed to permit movement of the medical device about the roll axis when mounted on the medical device supporting apparatus solely by grasping and applying force to at least one of the medical device and the device attachment portion. The connection mechanism can include holding structure on the base attachment portion engageable with the base member for holding the base attachment portion in a selected angular orientation about the roll axis with respect to the base member. The connection mechanism can mount the base attachment portion on the base member for movement in a release direction to release the holding structure of the base attachment portion from holding engagement with the base member and permit the base attachment portion to be rotated about the roll axis relative to the base member. The holding structure on the base member is typically configured to hold the base attachment portion in any one of plural, spaced apart angular orientations about the roll axis with respect to the base member. The holding structure on the base member can comprise one of a rib and grooves and the holding structure on the base attachment portion comprises the other of the rib and the grooves, the rib being receivable in one of the grooves at a time for holding the base attachment portion in a selected angular orientation about the roll axis with respect to the base member. The release direction of the first connection mechanism is typically along the roll axis. The connection mechanism can comprise a spring connected to the base member and the base attachment portion for biasing the base attachment portion into engagement with the base member. The device attachment portion typically comprises a retainer engageable with the medical device upon translational, sliding reception of the medical device on the device attachment portion to retain the medical device on the device attachment portion. The retainer can comprise a resilient detent positioned on the device attachment portion to be deformed by the medical device while the medical device moves translationally to slide onto the device attachment portion and to move back toward an undeformed position when a cooperating detent receiver of the medical device comes into registration with the resilient detent for retaining the medical device on the device attachment portion. The device attachment portion typically comprises a mount including a pair of retaining flanges, the retaining flanges diverging from each other generally from an upper part of the device attachment portion toward a lower part of the device attachment portion. The device attachment portion typically includes a rear wall and a bottom wall extending forwardly of the rear wall and positioned for engaging the medical device when mounted on the device attachment portion to support the medical device. The device attachment portion can include a side wall extending forwardly of the rear wall and positioned for engaging the medical device when mounted on the device attachment portion to support the medical device. A retaining arm may extend from the side wall. A tube holder can be mounted on the medical device mounting assembly. The tube holder can be formed integrally with the device attachment portion.

### BRIEF DESCRIPTION OF THE DRAWINGS

FIG. 1 is a perspective view of a medical device supporting apparatus;

FIG. 2 is a rear view of the apparatus;

FIG. 3 is a bottom view of the apparatus;

FIG. 4 is an exploded view of the apparatus;

FIG. 5 is a perspective of a clamping member of the apparatus;

FIG. 6 is a cross section of the clamping member through line 6-6 in FIG. 5;

FIG. 7 is a perspective view of a mounting assembly of the apparatus;

FIG. 8 is an exploded view of the mounting assembly;

FIG. 9 is a perspective view of a base attachment portion of the mounting assembly;

FIG. 10 is a perspective view of a device attachment portion of the mounting assembly;

FIG. 11 is a rear perspective view of an enteral feeding pump that can be supported by the medical device supporting apparatus;

FIG. 12 is a perspective view of the enteral feeding pump supported by the medical device supporting apparatus on an IV pole shown in phantom;

FIG. 13 is a front view of the medical device supported by the medical supporting apparatus in a first angular position about a roll axis of the medical supporting apparatus;

FIG. 14 is the front view of FIG. 13 but with the medical device rotated about the roll axis clockwise about 90 degrees from the position of FIG. 13;

FIG. 15 is a front view of FIG. 13 with the medical device in a tilted about a pitch axis of the medical supporting apparatus;

FIG. 16 is a rear perspective view of another medical device supporting apparatus;

FIG. 17 is a front perspective view of the medical device supporting apparatus of FIG. 16;

FIG. 18 is a front view of the medical device supporting apparatus of FIG. 17;

FIG. 19 is a top view of the medical device supporting apparatus of FIG. 17;

FIG. 20 is a bottom view of the medical device supporting apparatus of FIG. 17;

FIG. 21 is a perspective view of an enteral feeding pump supported by the medical device supporting apparatus of FIG. 17 on an IV pole shown in phantom

FIG. 22 is a front perspective of yet another medical device supporting apparatus; and

FIG. 23 is. a front view of the medical device supporting apparatus of FIG. 22.

Corresponding reference characters indicate corresponding pairs throughout the several views of the drawings.

### DETAILED DESCRIPTION

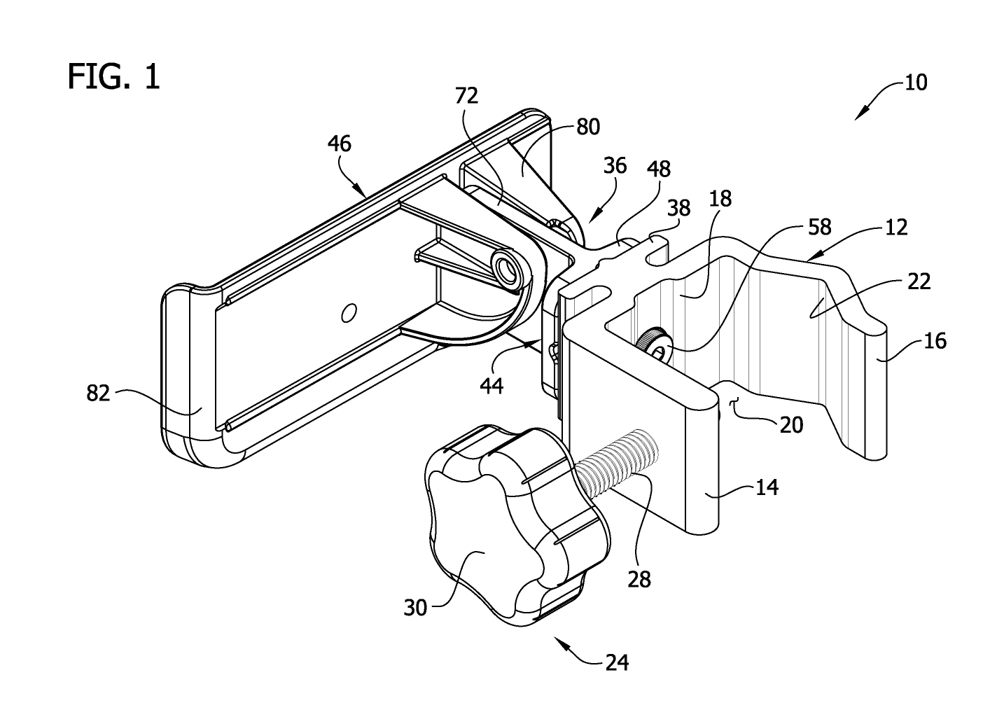

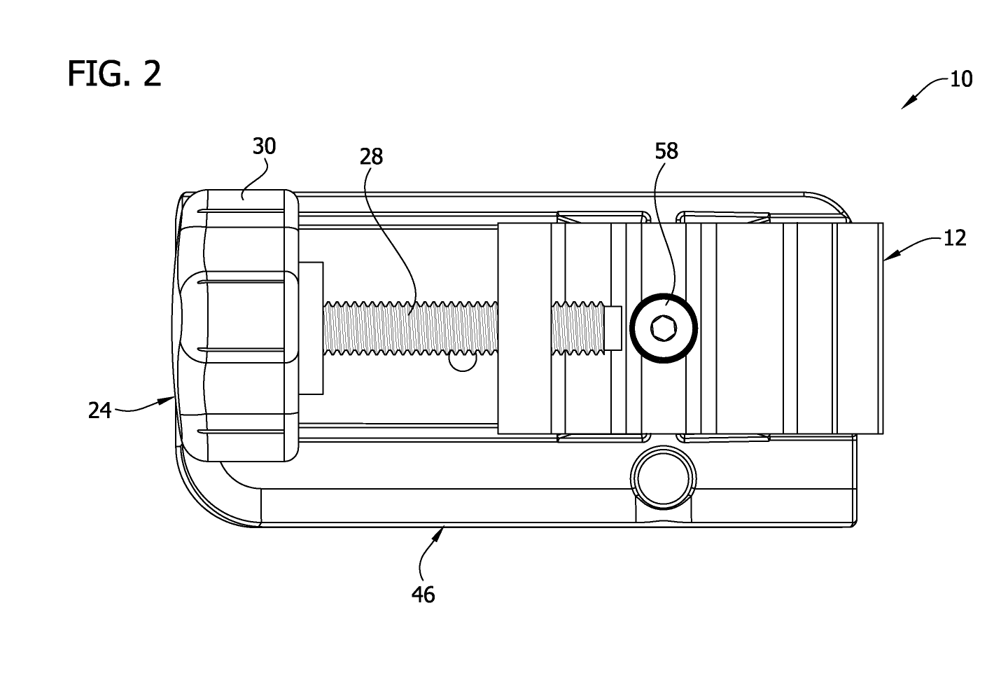

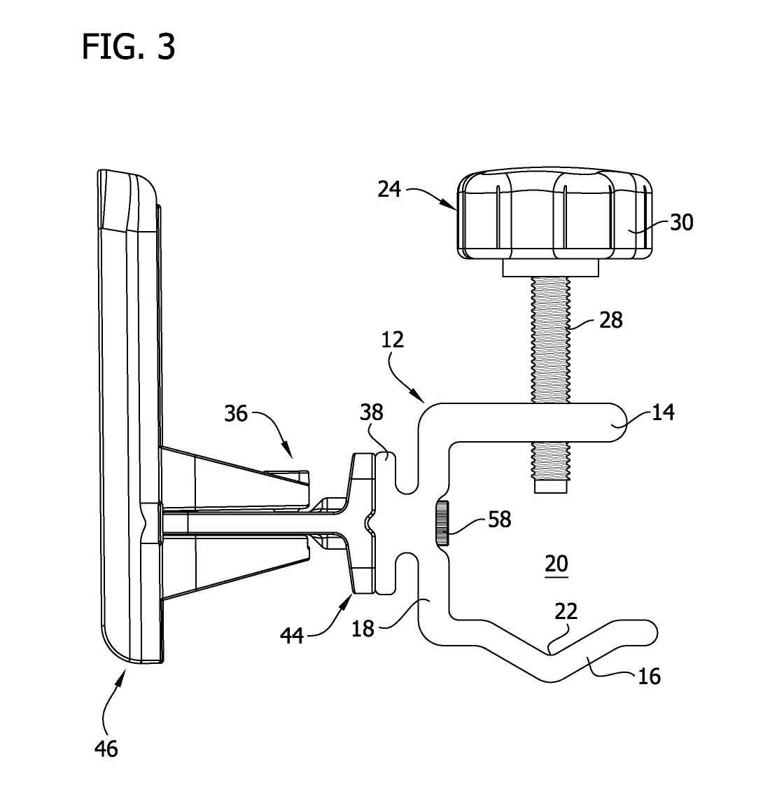

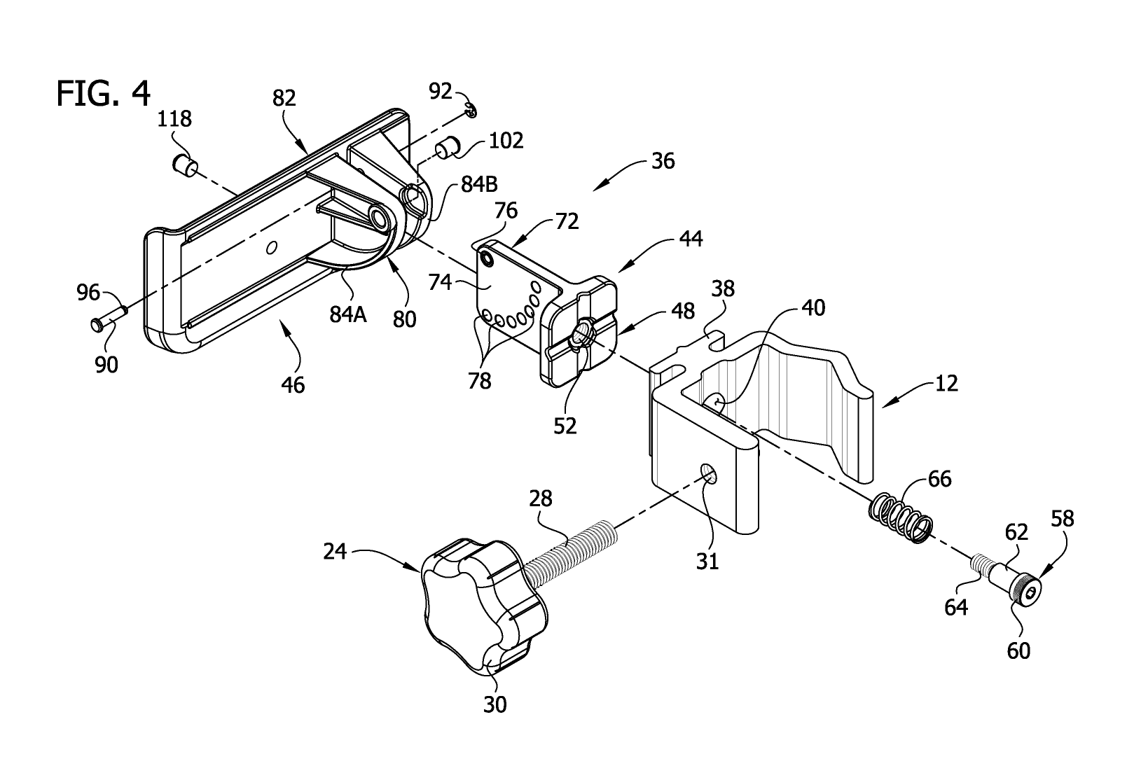

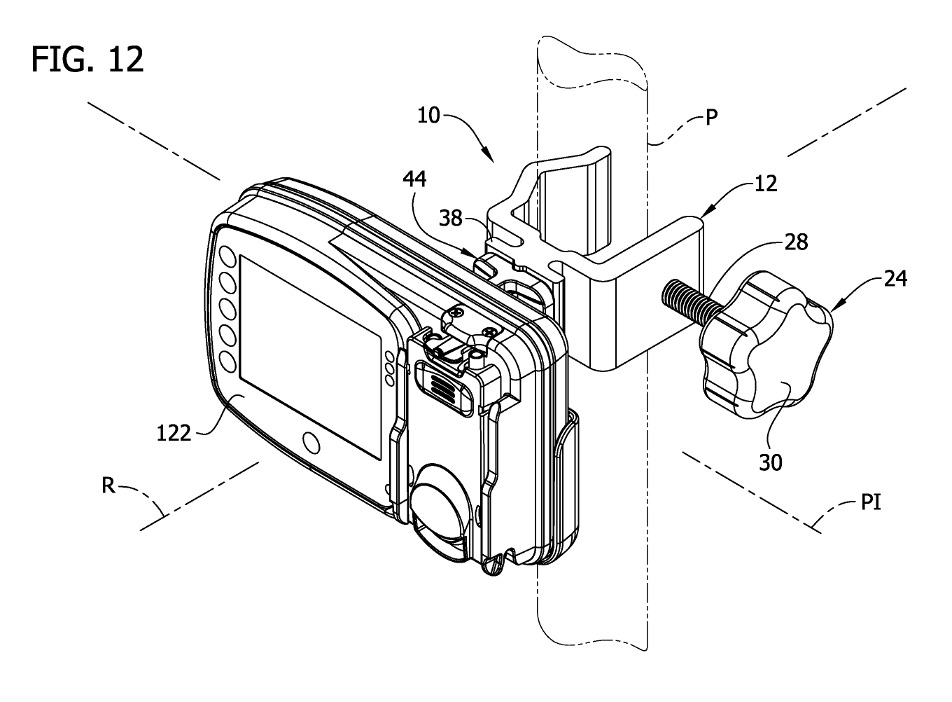

Referring to FIGS. 1-4 and 12, a medical device supporting apparatus indicated generally at 10 may be used to mount a medical device such as an enteral feeding pump 122 to a support structure, such as IV pole P shown in phantom in FIG. 12. The supporting apparatus 10 may include a base member, e.g., a generally C-shaped clamp member 12. It will be understood that other types of mounting members besides a clamp may be used. The clamp member 12 may include first and second arms 14, 16 and back portion 18, which together define a channel 20. Second arm 16 may have a V-shaped indention so as to define a pole-receiving notch 22. The supporting apparatus 10 may further include a securing member generally indicated at 24 by means of which the supporting apparatus is secured to the IV pole P (shown in phantom in FIGS. 12-15). It will be understood that the supporting apparatus can be secured to other support structures, such as a bed rail. The securing member may be suitably a threaded post 28 with a hand knob 30 attached to a proximal end thereof. The first arm 14 of the clamp member 12 may have a threaded hole 31 (FIG. 4) formed through it, generally across from the pole-receiving notch 22, into which the threaded post 28 screws. Thus, the supporting apparatus 10 may be secured to the IV pole P (e.g., as shown in FIG. 12) by unscrewing the threaded post 28 sufficiently to open up the channel 20; positioning the clamp member 12 around the IV pole, with the support structure received within the pole-receiving notch 22; and screwing the threaded post 28 down against the side of the IV pole, whereby the IV pole is clamped between a distal end of the threaded post and the pole-receiving notch.

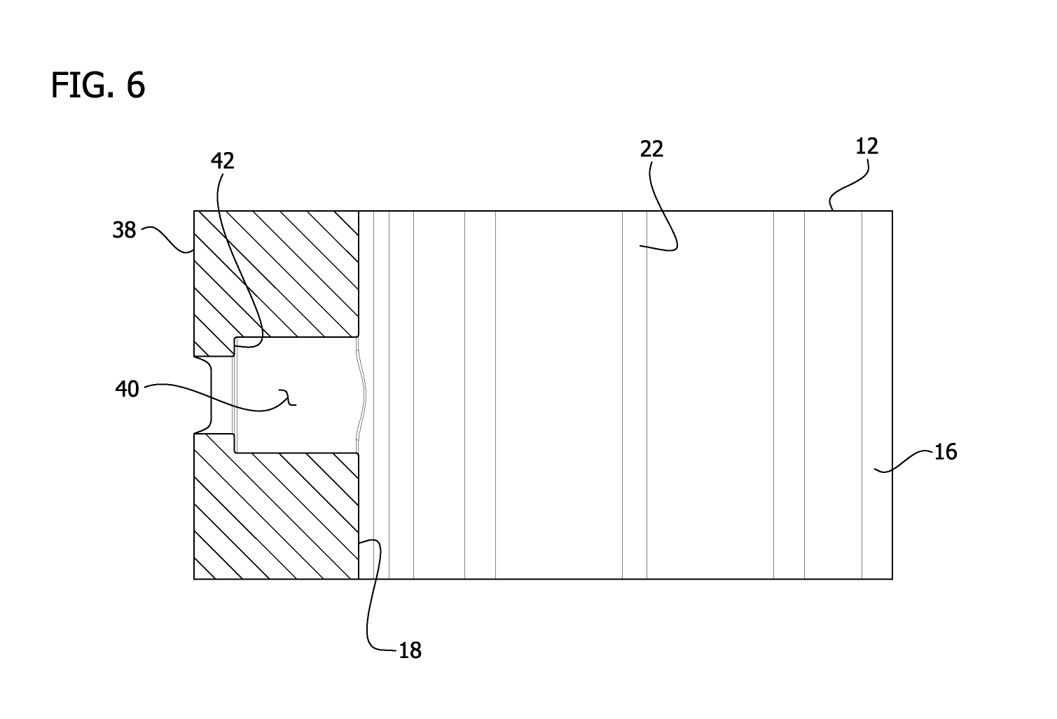

The medical device supporting apparatus 10 may further include a medical device mounting assembly 36 attached to the back portion 18 of the clamp member 12. In particular, a T-shaped mounting plate 38 may be attached to the back portion 18 and may be formed as one piece with the back portion. A hole 40 having a counterbore 42 (FIG. 6) may extend through the back portion 18 and mounting plate 38 for use in attaching the mounting assembly 36 to the clamp member 12 as will be explained in greater detail below. Further, the medical device mounting assembly 36 may be movably attached to the mounting plate 38 to allow a medical device mounted on the medical device mounting assembly to be adjusted relative to the clamp member 12 using a single user adjustment motion and releasably locked in place relative to the clamp member without the use of a lever or knob as will also be explained in greater detail below. It is envisioned that the mounting plate 38 may have a shape other than the T shape shown in the illustrated embodiment, or could be omitted altogether.

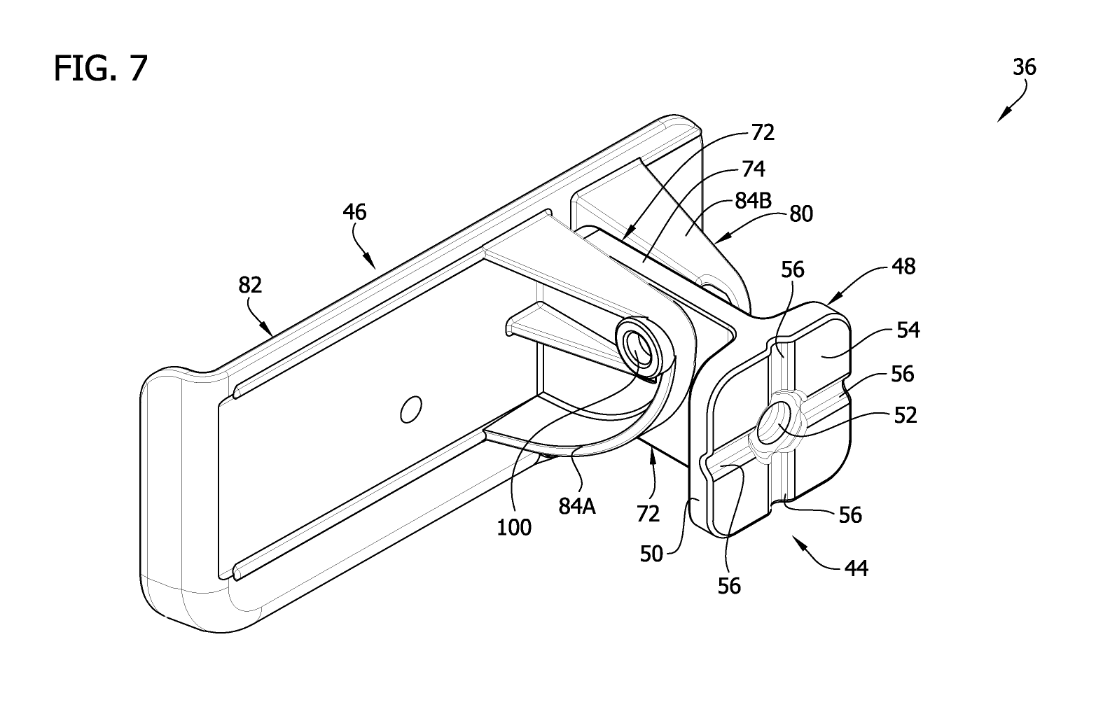

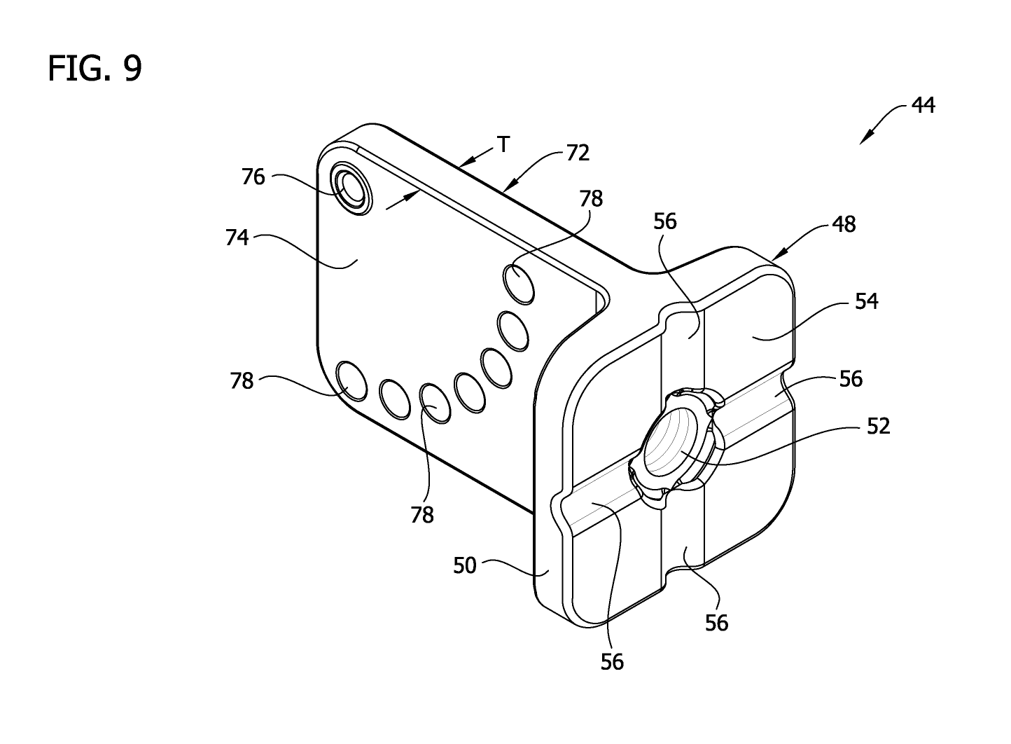

Referring to FIGS. 7-10, the medical device mounting assembly 36 may comprise a base attachment portion 44 movably attached to the clamp member 12 and a device attachment portion 46 movably attached to the base attachment portion. The base attachment portion 44 may comprise a clamp engaging element 48 including a plate member 50. A threaded bore 52 may be formed through a clamp engagement surface 54 of the plate member 50 and into the clamp engaging element 48. Circumferentially spaced and radially extending grooves 56 may be formed in the clamp engagement surface 50 and disposed around the threaded bore 52. A bolt 58 (FIG. 4) for securing the base attachment portion 44 to the clamp member may include a head 60, a smooth shaft portion 62, and a threaded shaft portion 64 at its distal end. The bolt 58 may extend through hole 40 in the clamp member 12 and threadedly engage the threaded bore 52 in the base attachment portion 44 to secure the base attachment portion to the clamp member 12. A spring 66 may be seated between the counterbore 42 (FIG. 6) and the head 60 of the bolt 58 to bias the base attachment portion 44, and in particular the clamp engagement surface 54, into contact with the mounting plate 38 of the clamp member 12. The spring 66 is compressible to move the base attachment portion 44 and hence the mounting assembly 36 in a release direction away from the clamp member 12 to unseat the engagement surface 54 of the base attachment portion 44 from the mounting plate 38 of the clamp member to allow rotation of the base attachment portion as will be explained in greater detail below.

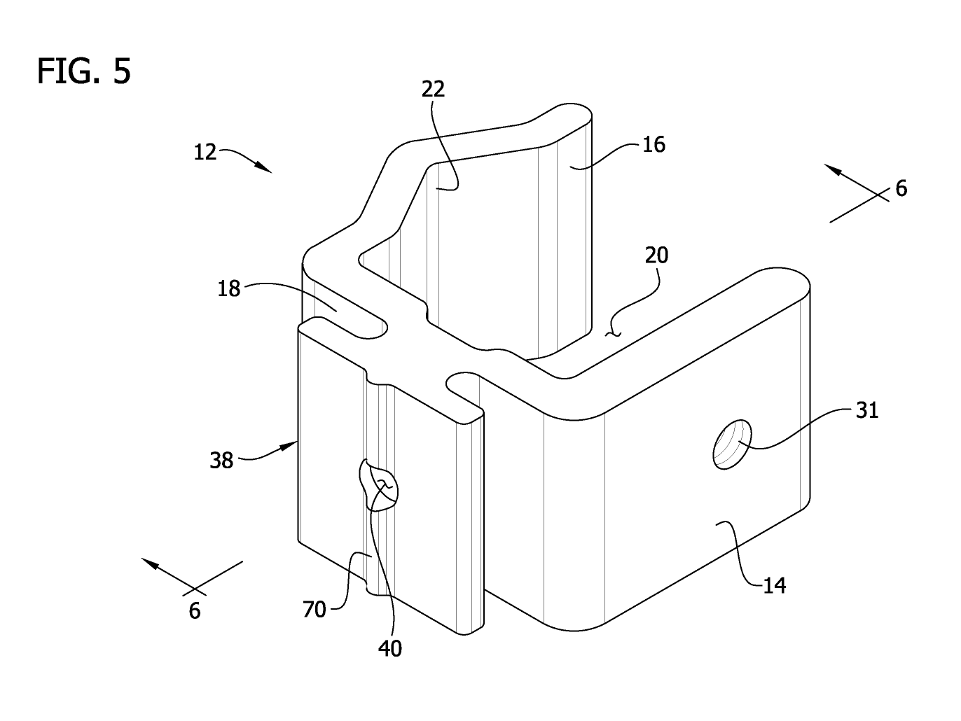

Referring to FIGS. 5 and 7, a locking rib 70 (broadly, “holding structure”) may be disposed on the mounting plate 38 and may be received in the grooves 56 (also broadly, “holding structure”) in the base attachment portion 44 to releasably lock the base attachment portion in a selected one of four possible angular orientations with respect to the clamp member 12. The rib 70 may have a ramped configuration to allow the grooves 56 to “ride up” the detent as a result of sufficient torque over a threshold amount being applied to the base attachment portion 44 to rotate it relative to the clamp member 12. This configuration may facilitate rotation of the base attachment portion 44 about roll axis R (FIG. 12) by imparting a torque of sufficient magnitude to the base attachment portion. The ramp action between the rib 70 and grooves 56 may facilitate movement of the base attachment portion 44 away from the mounting plate 38, thereby compressing the spring 66, to clear the rib 70 from the grooves 56, allowing the base attachment portion to rotate about the roll axis R. The interaction of the rib 70 and grooves 56 convert the torque into a force component extending along the roll axis R. Alternatively, because the base attachment portion 44 is spring biased, the base attachment portion can be pulled away from the clamp member 12, thereby compressing the spring 66, to clear the grooves 56 from the rib 70 by imparting a pulling force along the roll axis R on the base attachment portion prior to applying a rotational force to the base attachment portion. In this instance, only two forces are applied to cause rotation of the base attachment portion 44 relative to the clamp member 12.

In the illustrated embodiment, there is a single elongate rib 70 and four evenly spaced grooves 56 to provide indexed rotational positions spaced 90 degrees from each other. Greater or fewer than four grooves 56 having different positions can be used to provide different degrees of incremental rotation. For instance, eight evenly spaced grooves 56 can be used to provide a 45 degree incremental rotation. Still other degrees of incremental rotation are envisioned. Further, the rib 70 may be disposed on the base attachment portion 44 and the grooves 56 may be disposed in the mounting plate 38. The holding structure may take other forms than illustrated herein. For example and without limitation, if the holding structure of one or both of the clamp engaging surface 54 of the base attachment portion 44 and the opposing surface of the mounting plate 38 are formed for high friction interengagement, infinite rotational adjustment about the roll axis R may be achieved.

Referring to FIGS. 7-9, the base attachment portion 44 may also comprise a mounting element 72 for pivotally attaching the device attachment portion 46 to the base attachment portion. The mounting element 72 may comprise an elongate tab 74 projecting from the clamp engaging element 48. The tab 74 may include a pivot hole 76 generally at a free end of the tab and a plurality of locking recesses 78 (broadly, “detent receivers”) arcuately spaced from one another and extending generally from the free end of the tab to near a base of the tab. The locking recesses 78 are arranged in an arc about the pivot hole 76 to provide about 90 degrees of pivot adjustment between the device attachment portion 46 and the base attachment portion 44 about a pitch axis PI (FIG. 12). In the illustrated embodiment, the pivot hole 76 is disposed at a top of the free end of the tab 74, and a bottommost locking recess 78 is disposed at a bottom of the free end. It is envisioned that the base attachment portion 44 may have other shapes and the pivot hole 76 and locking recesses 78 may be disposed in other locations.

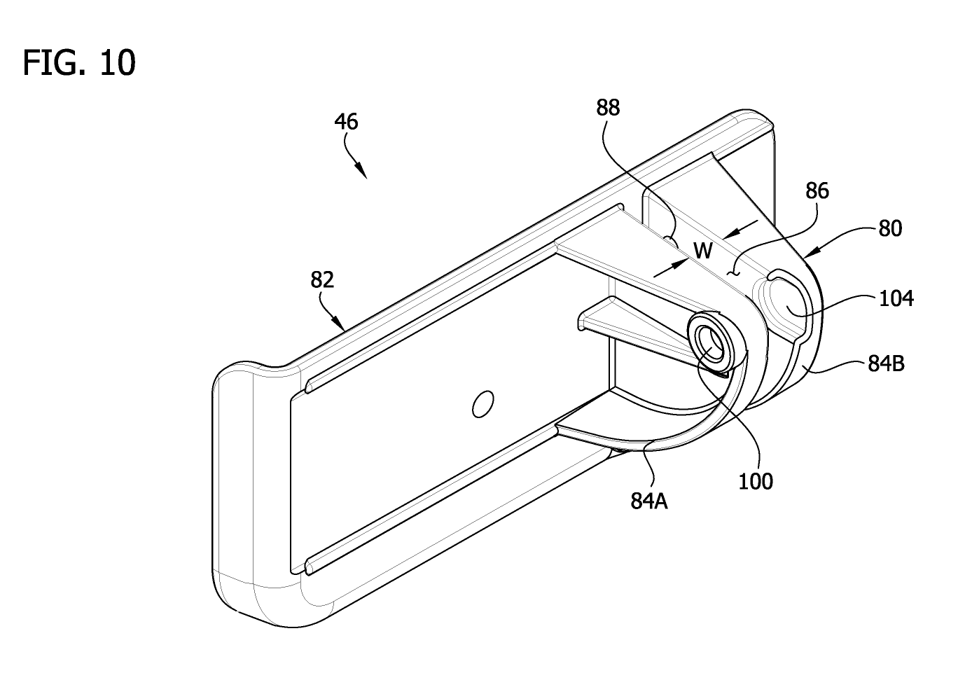

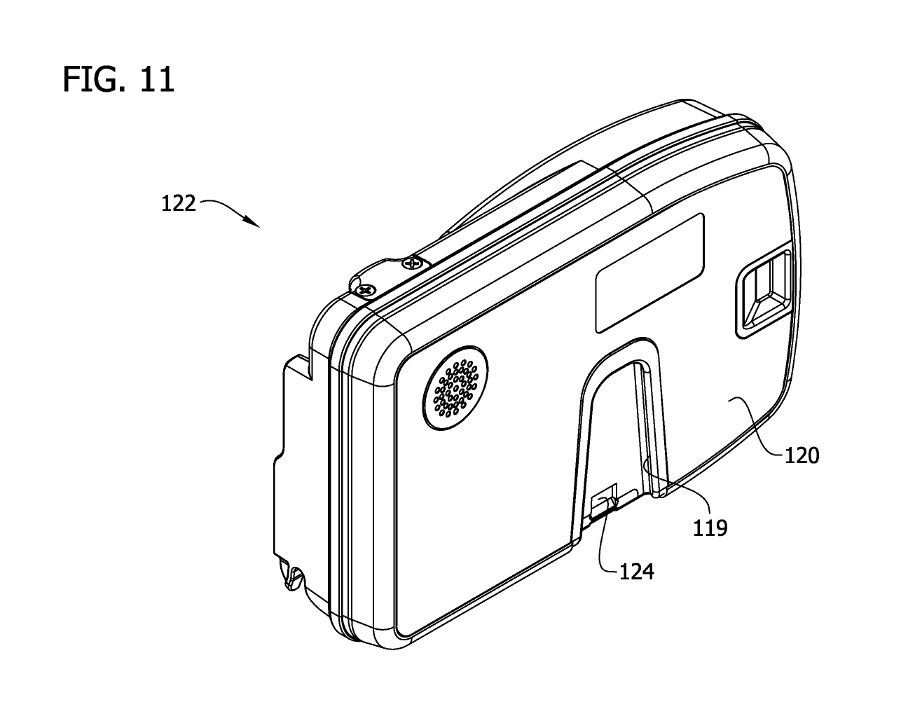

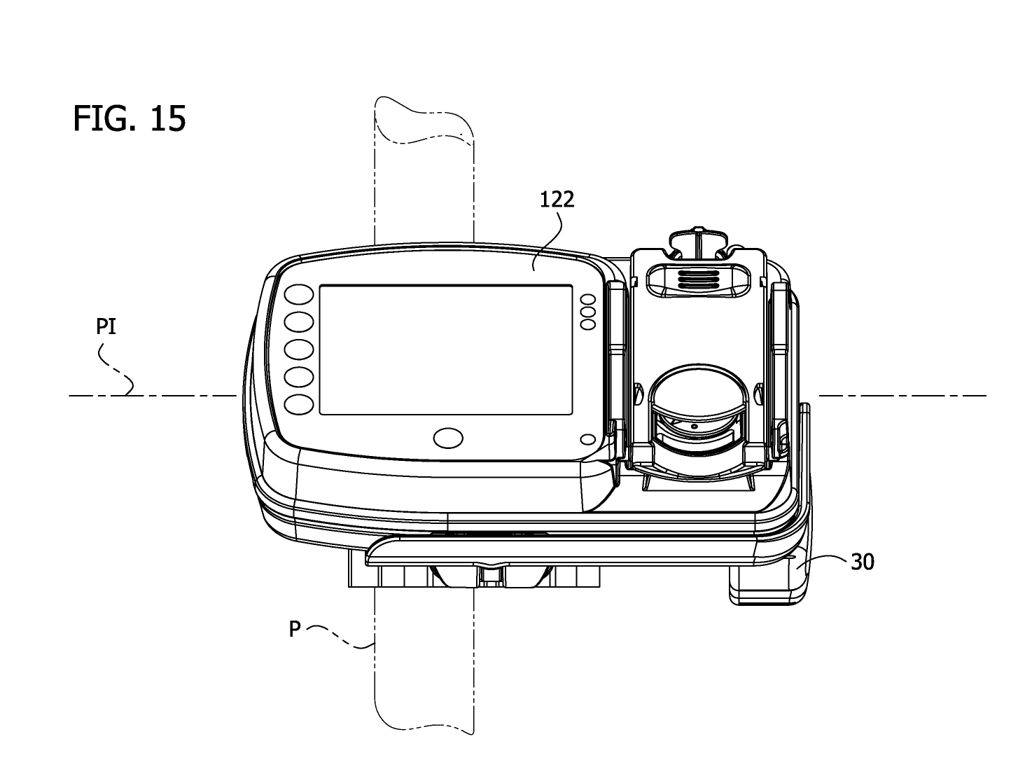

Referring to FIGS. 7, 8 and 10, the device attachment portion 46 may comprise a mounting element 80 for attaching to the mounting element 72 of the base attachment portion 44, and a device receiving element 82 for releasably attaching a medical device, such as the enteral feeding pump 122 shown in FIG. 11. The mounting element 80 may comprise a pair of spaced apart guide members 84A, 84B defining a guide channel 86 sized to receive at least a portion of the tab 74 of the base attachment portion 44. The guide members 84A, 84B may have aligned holes 88 (only one is shown in FIG. 10) near respective bases of the guide members for receiving a pivot pin 90 to mechanically link the device attachment portion 46 to the base attachment portion 44 for rotation about the pitch axis PI that extends through the centers of the holes 88. In particular, the pivot pin 90 may extend through the pivot hole 76 in the base attachment portion 44 and the aligned holes 88 in the device attachment portion 46 to pivotally link the device attachment portion to the base attachment portion. The pivot pin 90 may be secured in the pivot hole 76 and aligned holes 88 by a C-clip 92 having projections 94 extending into an annular channel 96 in the pivot pin 90. This connection allows the device attachment portion 46 to undergo a guided pivot motion relative to the base attachment portion 44 about the pitch axis PI. The guide channel 86 may have a width W slightly larger than a thickness T of the tab 74 to limit movement of the device attachment portion 46 relative to the tab along a single pivot axis T (FIG. 15).

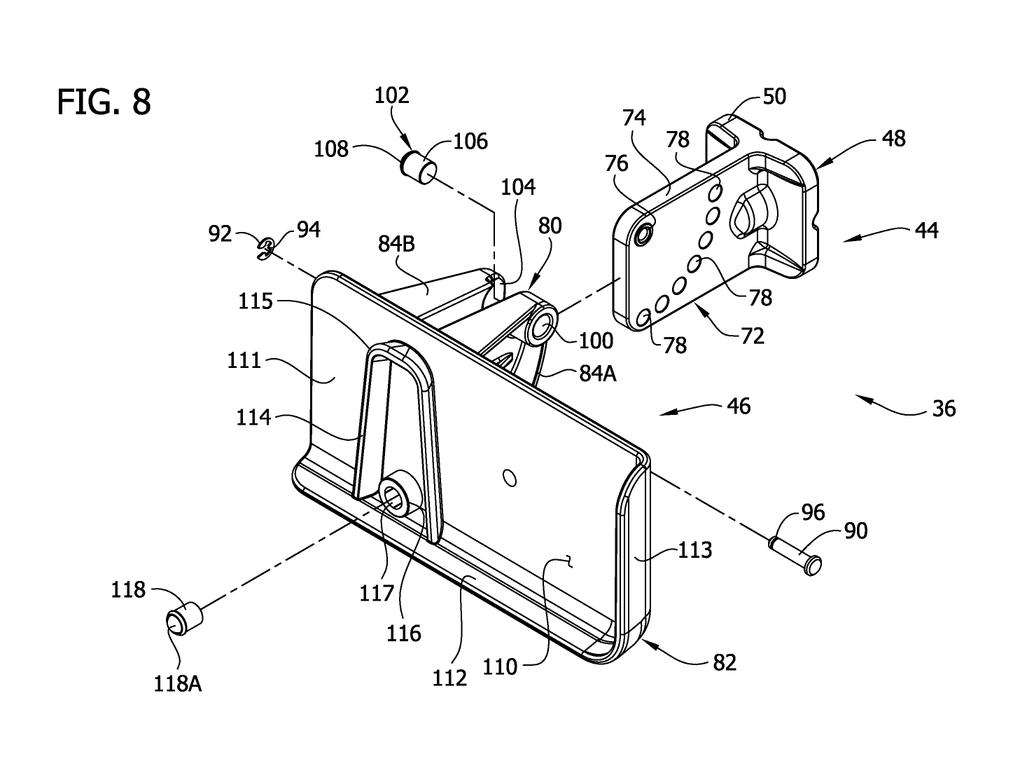

A detent hole 100 may be disposed near the top of guide member 84A for receiving a locking detent 102. A cutout 104 may be formed in guide member 84B and generally aligned with the detent hole 100 to provide a clearance for inserting the locking detent 102 into the detent hole 100 in guide member 84A. The locking detent 102 may comprise a base 106 and a rounded tip 108 (FIG. 8). The tip may be adapted for selective engagement with the locking recesses 78 in the base attachment portion 44. The tip 108 may also be spring loaded such that the tip is movable relative to the base 106. Movement of the tip 108 in this manner may be considered deformation of the locking detent 102. When the detent 102 is received in one of the locking recesses 78 and a torque of magnitude more than a threshold above the torque applied by the weight of the device attachment portion 46 plus the weight of the enteral feeding pump 122 (when attached thereto) is applied to the device attachment portion, a lip of the locking recess 78 may engage the tip 108 of the detent 102 and move the tip of the detent into the base 106 providing a clearance for the device attachment portion to pivot relative to the base attachment portion 44. Upon coming into registration with an adjacent locking recess 78, the spring loaded detent 102 may urge the tip 108 into the recess to again releasably lock the device attachment portion 46 in place on the base attachment portion 44. The locking detent 102 may have other configurations allowing the detent to releasably engage the locking recesses 78 in the base attachment portion 44. Alternatively, the tab 74 may be press fit into the guide channel 86 providing an infinite number of locking positions within the limited range of motion permitted between the mount members 44, 46.

The device receiving element 82 of the device attachment portion 46 may comprise a pocket 110 (FIG. 8) including a rear wall 111, a bottom wall 112 projecting forwardly from the rear wall and a side wall 113 projecting forwardly from the rear wall. A mount 114 may be disposed on the rear wall 112. In the illustrated embodiment, the mount 114 has a triangular or arched shape and includes a mounting flange 115 that diverges on opposite sides of the mount generally from a top of the device receiving element toward the bottom wall 112. A post 116 may be disposed on the engagement surface 112 and may have a receptacle 117 for receiving a retainer 118 including a resilient detent 118A. The mounting flange 115 of the mount 114 may be configured to slidingly engage a groove 119 formed in a back surface 120 of the enteral feeding pump 122 (FIG. 11) to mount the pump to the apparatus 10. Further, the resilient detent 118A of the retainer 118 may be configured to releasably engage a recess 124 in the back surface 120 of the pump 122 to releasably retain the pump to the device attachment portion 46. The retainer 118 may be constructed similarly to the detent 102 used to releasably lock the device attachment portion 46 in place on the base attachment portion 44. Thus, a single sliding motion is sufficient to engage the pump 122 with the device attachment portion 46 and releasably lock the pump to the medical device supporting apparatus 10. As the enteral feeding pump 122 slides onto the mount 114 the resilient detent 118A engages a lower edge of the pump and is moved (or “deformed”). Once the retainer 118 is in registration with the recess 124, the resilient detent 118A moves forwardly into the recess, retaining the pump on the device mounting portion 46. However, a sufficient upward force applied to the enteral feeding pump 122 can move the resilient detent 118A out of the recess 124, allowing pump to be removed from the device mounting portion 46 without manipulating any screws, release levers or the like.

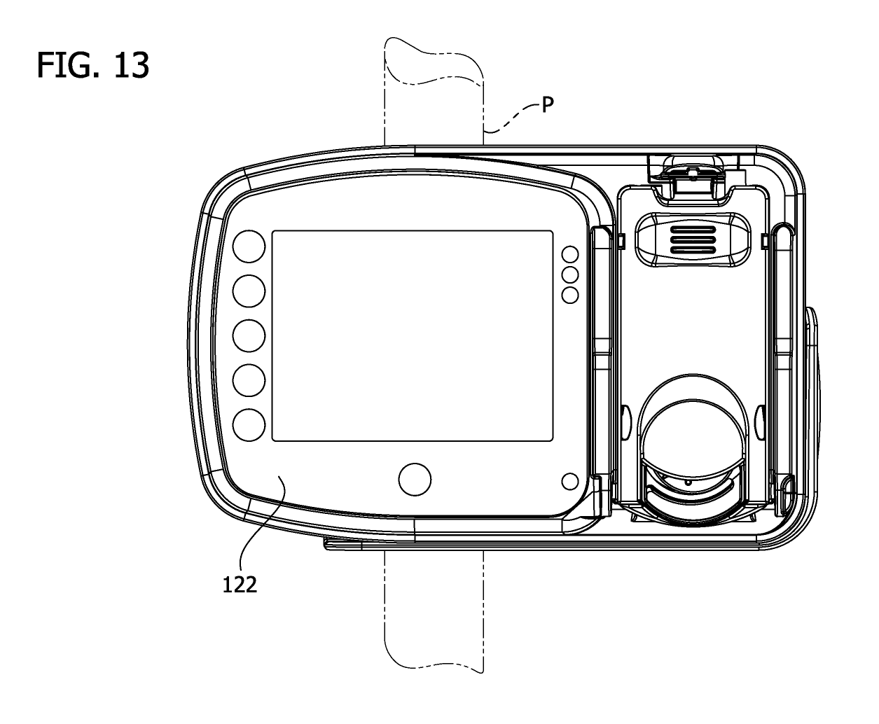

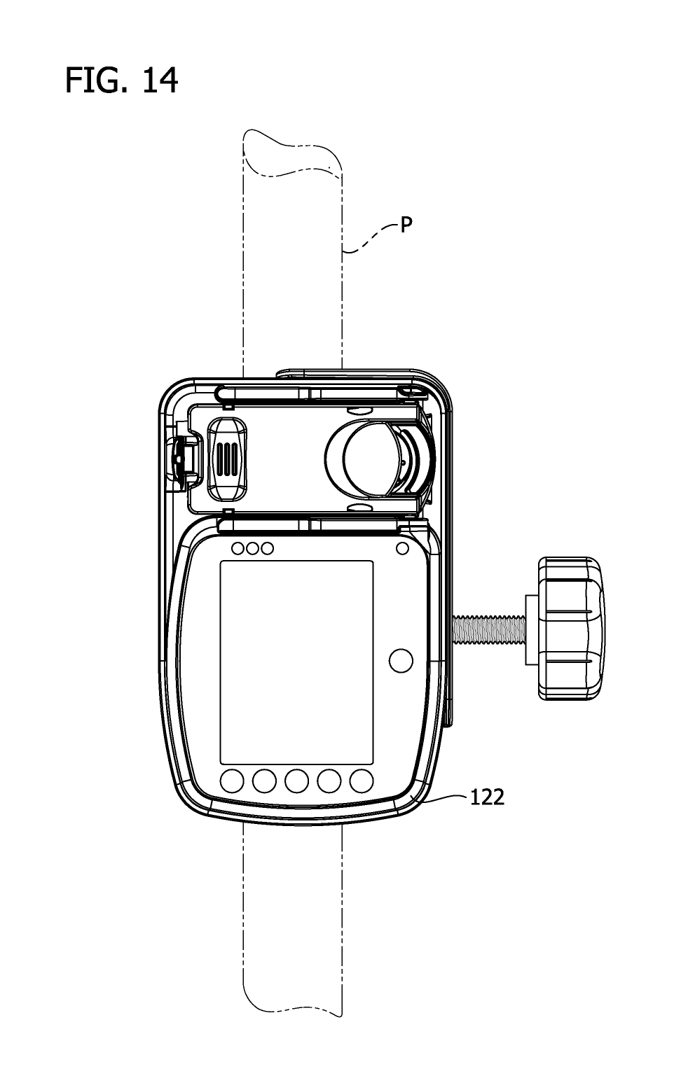

Referring to FIGS. 12-14, the enteral feeding pump 122 may be attached to the IV pole P using the medical device supporting apparatus 10. The configuration of the apparatus 10 allows a user to easily rotate the pump 122 about the roll axis R and the pitch axis PI solely through application of force to at least one of the pump 122 and the device mounting portion 46. No manipulation of screws, release levers, knobs and the like is required to change the position. More specifically to move the pump 122 to a selected rotational position (FIG. 14) about the roll axis R, the pump can be grasped and rotated by applying a torque that is more than a threshold amount above the torque needed to disengage the grooves 56 from the rib 70 by compressing the spring 66. This may also be accomplished by pulling the pump 122 outward in a direction along the roll axis R and then rotating the pump about the roll axis position. For example, two such positions of the pump about the roll axis are illustrated in FIGS. 13 and 14.

The pump 122 can also be tilted by applying a torque to the pump and/or the device mounting portion 46 of a sufficient magnitude to deform the locking detent 102 so that tip 108 is released from the corresponding locking hole 78. The pump can be pivoted about the pitch axis PI in this manner to reach any angular orientation permitted by the arrangement of the locking holes 78. An example of such an adjustment in angular orientation about the pitch axis PI is shown in FIGS. 13 and 15. In FIG. 13, the pump 122 is held so that it faces directly forward from the IV pole P. In FIG. 15, the pump 122 has been turned about the pitch axis PI to face slightly upwardly. Again, this can be accomplished without manipulating a screw, knob, lever and the like to first release the device attachment portion 46 before it can be pivoted. These features can be of particular importance when patients having muscle weakness, hand inflammation, or otherwise diminished fine motor skills use the apparatus 10.

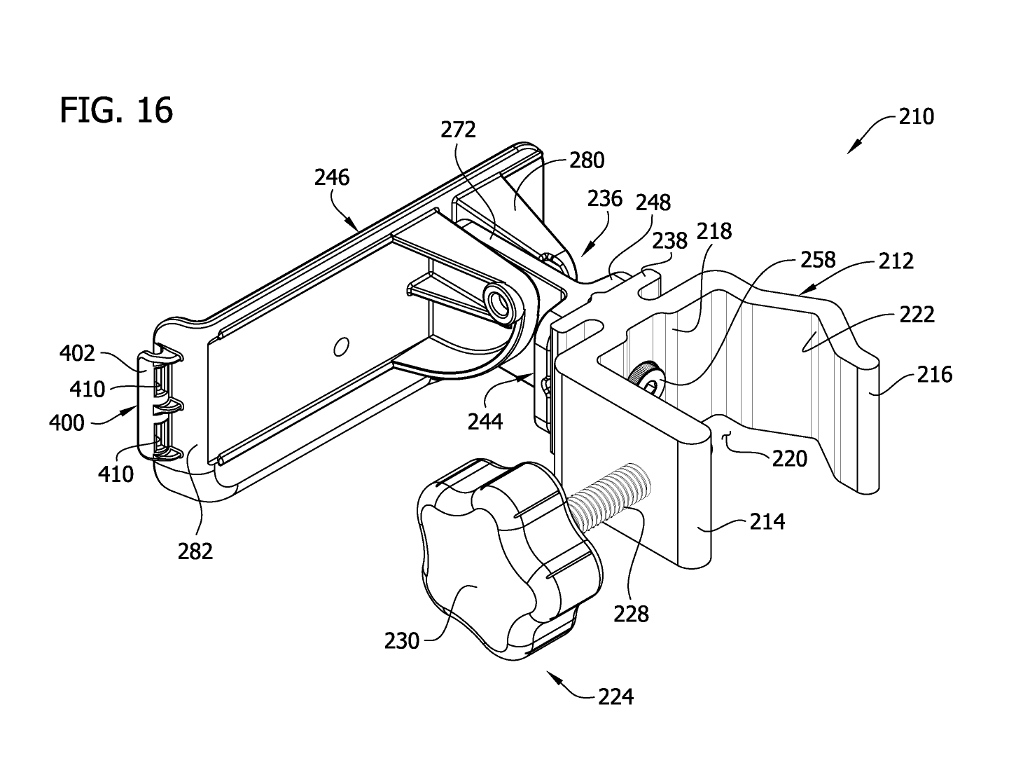

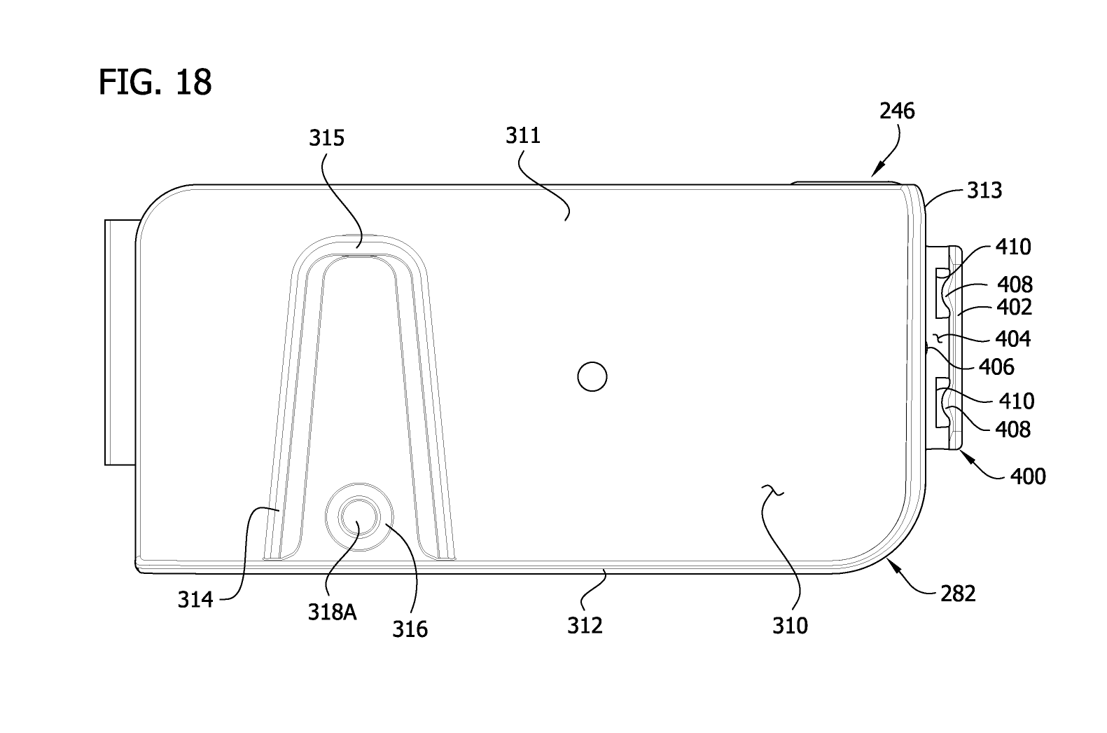

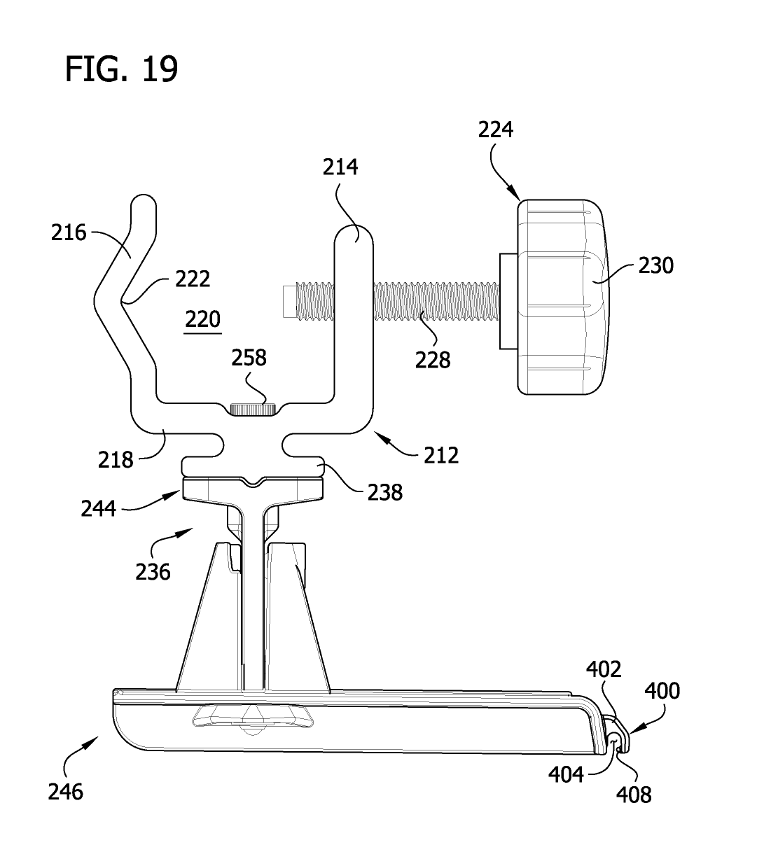

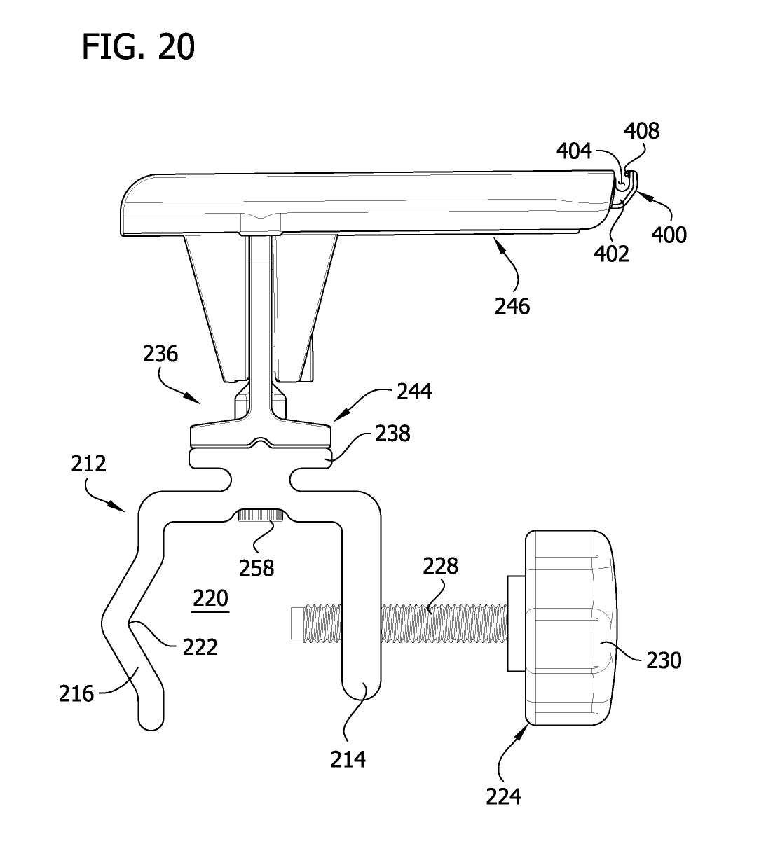

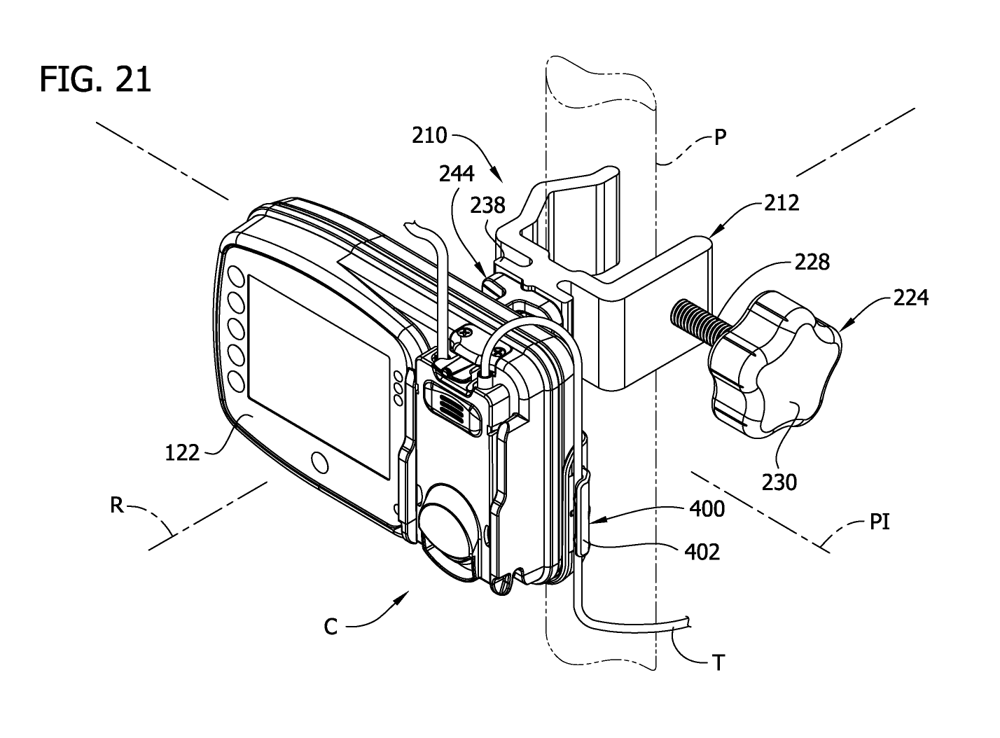

Referring now to FIGS. 16-21, another embodiment of a medical device supporting apparatus is generally indicated at 210. The medical device supporting apparatus 210 can be similar to the apparatus illustrated in FIGS. 1-15, therefore like parts are indicated by corresponding reference numerals plus 200. In this variant, apparatus 210 includes a tube holder 400 mounted on a side wall 313 of a device receiving element 282 of the apparatus. The tube holder 400 is configured to secure a portion of a tube T extending from a pump cassette C received in the enteral feeding pump 122 (FIG. 21). The tube holder 400 is sized and shaped to hold the tube T while preventing or at least reducing the likelihood of the tube from sliding lengthwise through the holder. This construction allows the portion of the tube T extending from the pump 122 to be retained in a gently curved configuration or “access loop” so as to hold the tube passage open while directing the tube downward toward the patient. If the tube T were allowed to extend directly down from the pump 122, it would increase the chances that the tube could become kinked, potentially blocking or inhibiting the flow of feeding solution to the patient which could result in a deficient or incomplete delivery.

The tube holder 400 may comprise an elongate curved or angled retention arm 402 directly engaging or formed as one piece with the side wall 313 at one end and extending from the side wall to a free end spaced away from the side wall. The side wall 313 and curved retention arm 402 define a channel 404 for receiving the tube T. A detent 406 on the side wall 313 and a pair of detents 408 on the retention arm 402 help secure and grip the tube T in the channel 404. Thus, the retention arm 402 not only retains the tube T within the channel 404, but can inhibit movement of the tube lengthwise of the tube within the channel. Cutouts 410 in the retention arm 402 add flexibility to the retention arm so that the retention arm can resiliently flex to receive the tube T past the detents 406, 408 and into the channel 404. In the illustrated embodiment the tube holder 400 is formed integrally with the device receiving element 282. However, the tube holder 400 could be formed separately from the device receiving element 282 and attached to the device receiving element by suitable means.

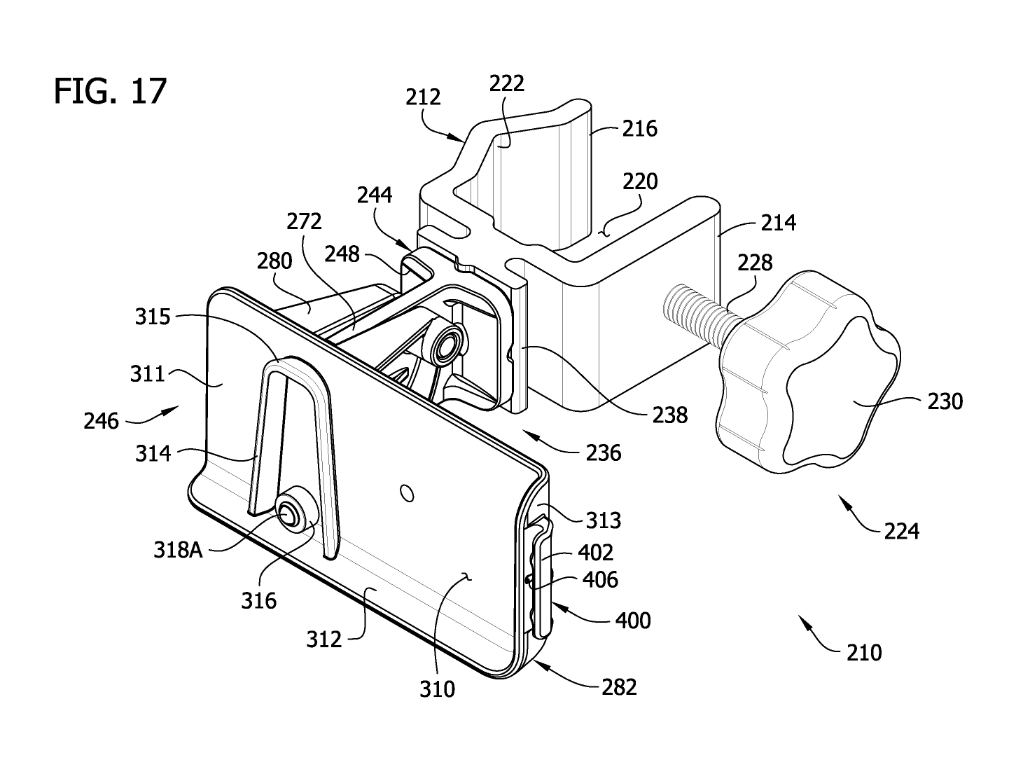

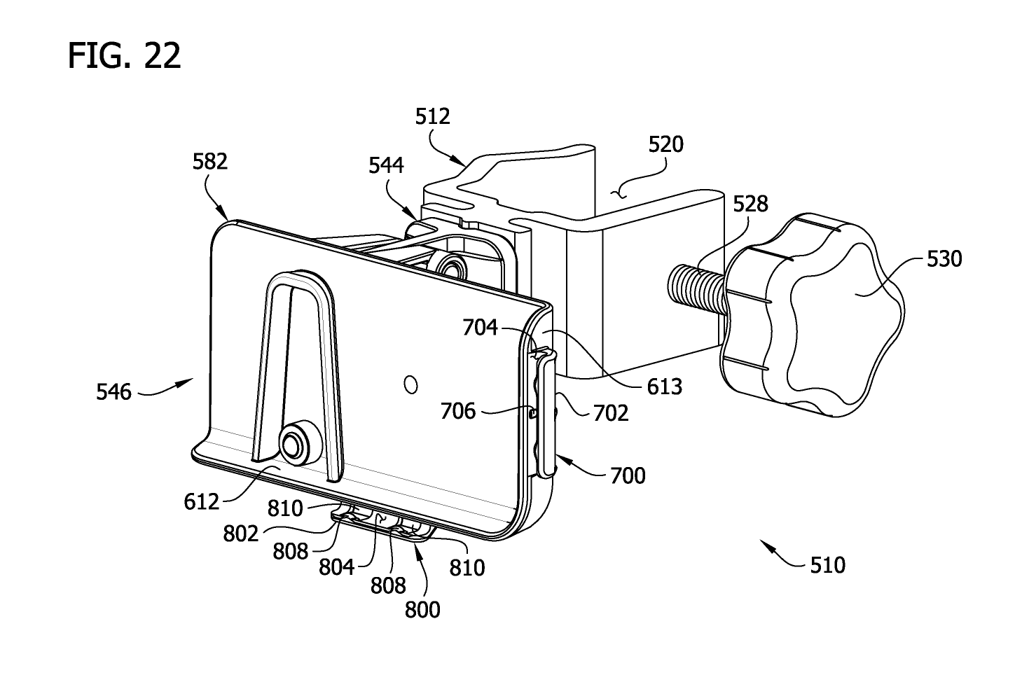

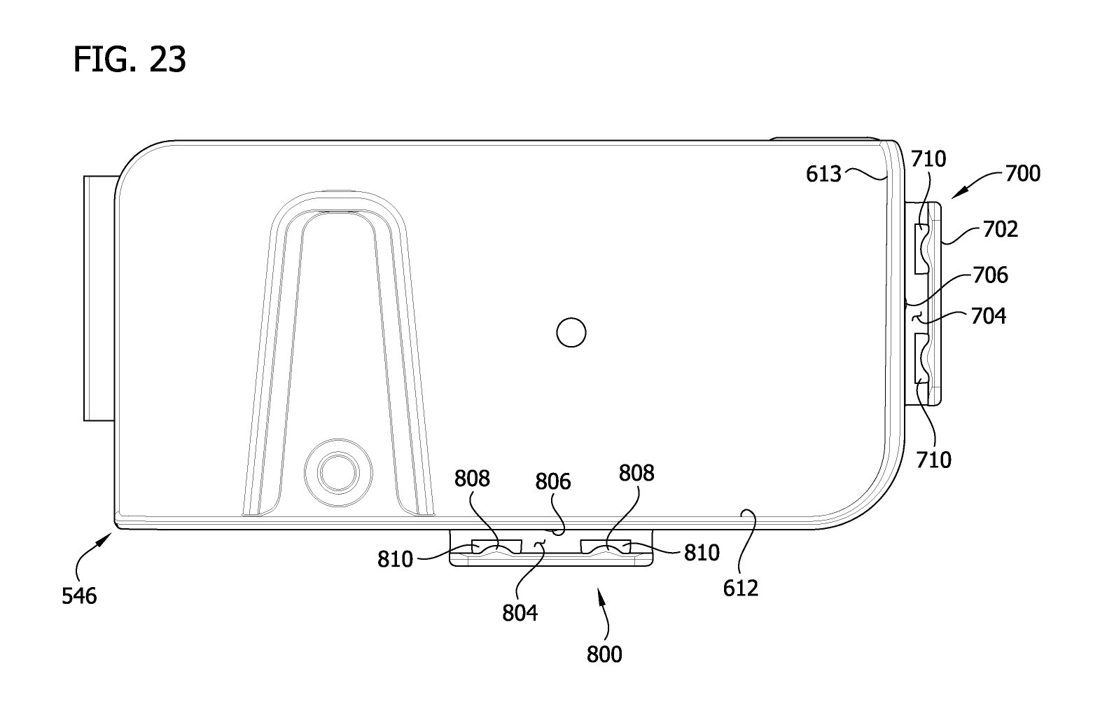

FIGS. 22 and 23 illustrate a further embodiment of a medical device supporting apparatus 510 constructed according to the principles of the present invention. The construction of the medical device supporting apparatus 510 can be similar to the apparatus 210 shown in FIGS. 17-21. Therefore, corresponding parts will be given the same reference numeral as given in FIGS. 17-21, plus 300. The medical device supporting apparatus 510 includes a first tube holder 700 that can be constructed and located the same as the tube holder 400 of the FIGS. 17-21 embodiment. In addition, the medical device supporting apparatus may include a second tube holder 800 disposed on the underside of the bottom wall 612 of the device receiving member 582 of the device attachment portion 546.

The construction of the second tube holder 800 may be the same as that of the first tube holder 700, comprising a curved or angled retention arm 802 directly engaging or formed as one piece with the bottom wall 612 at one end and extending from the bottom wall to a free end spaced away from the bottom wall. The bottom wall 612 and curved retention arm 802 define a channel 804 for receiving the tube T. A detent 806 (FIG. 23) on the bottom wall 612 and a pair of detents 808 on the retention arm 802 help secure and grip the tube T in the channel 804. Cutouts 810 in the retention arm 802 add flexibility to the retention arm so that the retention arm can resiliently flex to receive the tube T past the detents 806, 808 and into the channel 804. In the illustrated embodiment the second tube holder 800 is formed integrally with the device receiving element 582. However, the tube holder 800 could be formed separately from the device receiving element 582 and attached to the device receiving element by suitable means. The first and second tube holders 600, 700 may be used in tandem to route the tube T down the side wall 613 of the device receiving member 582 and under the bottom wall 612 to a patient located to the left (as seen in FIGS. 22 and 23). The first and second tube holders 700, 800 hold the tube T in a gently curving configuration so that the tube T does not become obstructed because of kinking or other deformation of the tube as it is routed from the pump held in the device receiving element 582 to the patient. The location and number of tube holders may be other than described herein within the scope of the present invention, for example, as needed for a particular pump configuration to route the tube to patient without kinking the tube.

When introducing elements of the present invention or the preferred embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above construction without departing from the scope of the invention, it is intended that all matter contained in the above description or shown in the accompanying drawings shall be interpreted as illustrative and not in a limiting sense. It is understood that any of the particular embodiments of the present invention may include one or more of the aspects or features of the invention as described herein and illustrated in the drawings.

1. A medical device supporting apparatus for use in a medical environment to releasably secure to a support structure a medical device for delivering fluid to a patient through a tube, the medical device supporting apparatus comprising:
a base member configured to releasably mount the medical device supporting apparatus on the support structure; and
a medical device mounting assembly including a device attachment portion configured to receive the medical device, and a tube holder supported by the device attachment portion for holding the tube.

2. The medical device supporting apparatus as set forth in claim 1, wherein the tube holder is configured to grip the tube for resisting movement to the tube with respect to the tube holder in a direction lengthwise of the tube.

3. The medical device supporting apparatus as set forth in claim 1, wherein the tube holder includes detents for engaging the tube when received in the tube holder.

4. The medical device supporting apparatus as set forth in claim 1, wherein the tube holder comprises a retention arm configured to form a channel for receiving the tube.

5. The medical device supporting apparatus as set forth in claim 4, wherein the retention arm includes at least one cutout.

6. The medical device supporting apparatus as set forth in claim 1, wherein the tube holder constitutes a first tube holder, and wherein the medical device supporting apparatus further comprises a second tube holder.

7-55. (canceled)

56. The medical device supporting apparatus as set forth in claim 1, wherein the medical device mounting assembly further comprises a base attachment portion, the device attachment portion connected to the base attachment portion, the base attachment portion further including a first connection mechanism mounting the base attachment portion on the base member for rotation about a roll axis relative to the base member whereby the medical device mounting assembly can hold the medical device at different selected angles about the roll axis with respect to the base member, and a second connection mechanism pivotally mounting the device attachment portion on the base attachment portion for pivoting relative to the base attachment portion about a pitch axis that is generally transverse to the roll axis.

57. The medical device supporting apparatus as set forth in claim 56, wherein the first connection mechanism and second connection mechanism are constructed to permit movement of the medical device about the roll axis and about the pitch axis when mounted on the medical device supporting apparatus solely by grasping and applying force to at least one of the medical device and the device attachment portion.

58. The medical device supporting apparatus as set forth in claim 57, wherein the first connection mechanism includes holding structure on the base attachment portion engageable with the base member for holding the base attachment portion in a selected angular orientation about the roll axis with respect to the base member.

59. The medical device supporting apparatus as set forth in claim 58, wherein first connection structure mounts the base attachment portion on the base member for movement in a release direction to release the holding structure of the base attachment portion from holding engagement with the base member and permit the base attachment portion to be rotated about the roll axis relative to the base member.

60. The medical device supporting apparatus as set forth in claim 59, wherein the first connection mechanism further includes holding structure on the base member that is engaged with the holding structure of the base attachment portion to hold the base attachment portion in the selected angular orientation about the roll axis with respect to the base member.

61. The medical device supporting apparatus as set forth in claim 59, wherein the release direction of the first connection mechanism is generally along the roll axis.

62. The medical device supporting apparatus as set forth in claim 56, wherein the second connection mechanism mounts the device attachment portion on the base attachment portion for pivoting of the device attachment portion about the pitch axis to any one of plural indexed positions.

63. The medical device supporting apparatus as set forth in claim 62, wherein the second connection mechanism comprises one of a locking detent and detent receivers on the device attachment portion and the other of the locking detent and the detent receivers on the base attachment portion.

64. The medical device supporting apparatus as set forth in claim 56, wherein the device attachment portion is constructed for translational, sliding reception of the medical device into mounting engagement with the device attachment portion.

65. The medical device supporting apparatus as set forth in claim 64, wherein the device attachment portion comprises a retainer engageable with the medical device upon translational, sliding reception of the medical device on the device attachment portion to retain the medical device on the device attachment portion.

66. The medical device supporting apparatus as set forth in claim 64, wherein the retainer comprises a detent positioned on the device attachment portion to be deformed by the medical device while the medical device moves translationally to slide onto the device attachment portion and to move back toward an undeformed position when a cooperating detent receiver of the medical device comes into registration with the detent for retaining the medical device on the device attachment portion.

67. The medical device supporting apparatus as set forth in claim 64, wherein the device attachment portion comprises a mount including a pair of retaining flanges, the retaining flanges diverging from each other generally from an upper part of the device attachment portion toward a lower part of the device attachment portion.

68. The medical device supporting apparatus set forth in claim 1 wherein the mounting assembly further comprises a connection mechanism operatively connecting the device attachment portion to the base member for pivoting about a pitch axis relative to the base member, the device attachment portion being constructed for translational, sliding reception of the medical device into mounting engagement with the device attachment portion.

69. The medical device supporting apparatus as set forth in claim 1 wherein the mounting assembly further comprises a base attachment portion, the device attachment portion connected to the base attachment portion, the base attachment portion further including a connection mechanism mounting the base attachment portion on the base member for rotation about a roll axis relative to the base member whereby the medical device mounting assembly can hold the medical device at different selected angles about the roll axis with respect to the base member, the device attachment portion being constructed for translational, sliding reception of the medical device into mounting engagement with the device attachment portion.
